(19) United States
(12) Patent Application Publication
(10) Pub. No.: US 2003/0159030 A1
(43) Pub. Date: Aug. 21, 2003

(54) Method and system for the secure transmission of a portion of a web page over a computer network

(75) Inventor: Junius A. Evans, Carlsbad, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: iMetrikus, Inc.

(21) Appl. No.: 10/077,082

(22) Filed: Feb. 15, 2002

(51) Int. Cl. H04L 9/00

(52) U.S. Cl. 713/154

(57) ABSTRACT

A method of transmitting data over a network in a secure manner while keeping overhead low is described. Various components for a web page are retrieved and a web page is formed. The web page has some components in which sensitive data is stored in XML data islands. It is then determined which of the XML data islands contains sensitive data, such as health or medical data or financial data that is specific to an individual. These XML data islands are encrypted using an appropriate encryption routine, not limited to SSL. Once the data islands containing the sensitive data are encrypted they are transmitted over a network. The encryption routine used to secure the sensitive data is chosen based on the level of security desired before sending the data over the network and the amount of overhead resulting from the encryption that the user is willing to accept. The overhead can be reduced by using a less rigorous encryption routine and thereby increasing performance and speed. If the data requires a high degree of security, a powerful encryption routine can be used while increasing the overhead of the data when sending the data over a network.

### FIELD OF THE INVENTION

The present invention relates to methods of transmitting data between nodes in a network in a secure manner without sacrificing performance. In particular, it relates to a method of encrypting a portion of data from a web page and transmitting the web page between nodes in a network.

### BACKGROUND OF THE INVENTION

Two issues that are becoming increasingly important in transmitting data between nodes over a computer network, specifically a global computer network, are security of the data and transmission speed. The security of data, particularly sensitive data such as health and medical information or financial information, has always been an issue when receiving and sending information over a network. The information must be secure, that is, encrypted or protected before being transmitted on a public network. However, the information must be transmitted at an acceptable speed as well. Users' expectations are such that two to three minute wait times are not acceptable for transmission of a few web pages.

The most common method of securing data before sending it over the internet is using Secure Socket Layer (SSL) developed by Verisign Corporation. SSL, a component in most browsers and web servers, uses either 40-bit or 128-bit keys. When using SSL to send data, all the data being sent (typically all stored in one directory), is encrypted, regardless of whether the data is sensitive or not. That is, even if only a portion of the data is sensitive, the entire web page must still be encrypted. Sensitive data is defined as data that should be encrypted or secured before being transmitted over a network. When sending a large volume of data which is not sensitive, using SSL to encrypt the data is inefficient. Generally, SSL adds approximately 50 to 70% additional data volume or overhead, such as additional processes for encrypting and decrypting, to the original data. Thus, a 20 kb page, after being encrypted using SSL, can swell to 40 to 70 kb since every bit of data is encrypted. SSL reads the entire page of data and encrypts all of it. Although it is technically possible to encrypt select parts of a web page, the user messaging protocol in SSL makes doing so impractical and unworkable. As noted, a web page secured using SSL is stored in one directory or, in other words, SSL is applied to all data in a particular directory. If data outside the ‘SSL’ directory is sent along with SSL-encrypted data, the user gets a series of warning messages, e.g., “Leaving a Secure Site” or “Some content may not be secure”, indicating that some of the data being sent is not secure; however, the messages do not specify which data is not secure. Ambiguity of this sort diminishes confidence and may cause confusion among consumers using SSL when sending sensitive data and, thereby, decreases the likelihood that they will use it.

Sending large amounts of encrypted data also decreases performance because the time taken to transmit the data increases significantly. In contexts where large amounts of data are being sent, as opposed to a few items, e.g., a credit card number, social security number, etc., using SSL to secure the data is a significant drawback as it impacts performance to the point where consumers will likely not use the system. This is particularly true in cases where the consumer interacts with the data, adds and modifies data, thereby requiring that numerous scripts be transmitted with the “regular” data. In addition to the regular data, there may be many images, such as graphs and charts, and interactive database data. The weight of all these components can accumulate to the point where using SSL would require waiting several minutes to download data.

### SUMMARY OF THE INVENTION

In one aspect of the present invention, a method of transmitting data over a network in a secure manner while keeping overhead low is described. Various components of a web page are retrieved and a web page is formed. Some of the components contain sensitive data stored in XML data islands. It is then determined which of the XML data islands contains sensitive data, such as health or medical data or financial data that is specific to an individual. These XML data islands are encrypted using an appropriate encryption routine, not limited to SSL. Once the data islands containing the sensitive data are encrypted they are transmitted over a network. The encryption routine used to secure the sensitive data is chosen based on the level of security desired. This is done before sending the data over the network. The encryption routine selected also depends on the amount of overhead resulting from the encryption that the user is willing to accept. The overhead can be reduced by using a less rigorous encryption routine and thereby maintaining higher performance and speed. If the data requires a high degree of security, a more powerful encryption routine can be used while increasing the overhead of the data when sending the data over a network. The present invention gives the user the flexibility to decide which data elements should be encrypted and to format that data using XML, and specifically storing it as XML data islands. In this manner, the user is not required to encrypt the entire web page but rather only the relevant portions of the page.

In another aspect of the present invention, a method of sending secure data over a network is described. A service provider or user determines which data is to be secured before transmitting the data over a network. For example, certain aspects of a person's health or medical information should be secure rather than the person's entire health profile, much of which may contain public or non-sensitive data. Once the sensitive data has been identified, it is formatted in XML and stored in an XML data island. Nodes of the XML data islands are then encrypted using an appropriate encryption routine selected by the user and is not limited to SSL. The XML data islands are then sent with the rest of the web page containing non-encrypted data.

### BRIEF DESCRIPTION OF THE DRAWINGS

FIG. 1 is a block diagram displaying various components of a byte-heavy web page containing sensitive and non-sensitive data to be transmitted over a network.

FIGS. 2A and 2B are flow diagrams of a process of securing or encrypting selected portions of a web page and transmitting the entire web page over a network in accordance with one embodiment of the present invention.

### DETAILED DESCRIPTION OF THE PREFERRED EMBODIMENTS

When transmitting data over a network, it is preferable to encrypt only the portion of data that is sensitive, such as personal health and medical information or individual financial information, before sending it over a network. This should be done in a manner that would retain the consumer's confidence that the sensitive data being transmitted on a public network is secure. It should also be done in a manner that does not significantly impede performance, that is, the speed at which the data is transmitted.

Methods and systems for encrypting selected portions of data from a web page before transmitting the web page over a network are described in the various figures. Sending a large volume of data or data having more volume than a few sensitive items (e.g., credit card number, social security number) can be cumbersome using the widely used SSL tool. Often, when sending a byte-heavy page over a network, only certain parts of the page are truly sensitive and need to be encrypted before being transmitted over a network. The present invention describes methods in which only selected portions of a byte-heavy web page are encrypted and sent over a network and is done so without damaging consumer confidence or creating ambiguity. By reducing the amount of data that is encrypted, performance of the system remains acceptable as opposed to a significant slowdown when transmitting an entire web page in a secured manner.

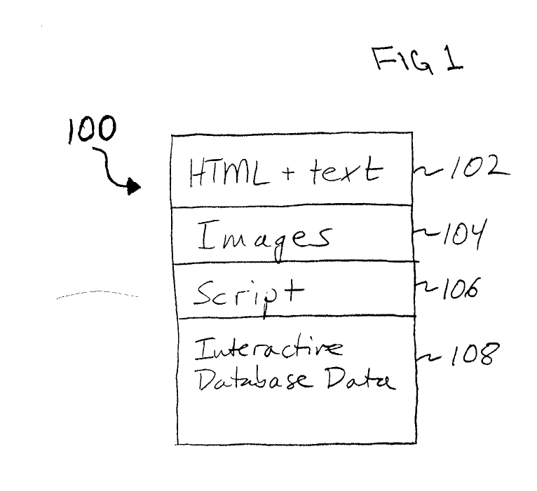

One context where a relatively large volume of data containing various types of data components is transmitted across a network is the transmission of an individual's health profile containing years of medical data, drug and prescription data, graphics, medical and wellness charts, and the like. Another example is sending an individual's financial data which may also contain years of data, stock trading history, portfolio data, and the like. FIG. 1 is a block diagram of various components comprising an example of a byte-heavy web page containing sensitive and non-sensitive data to be transmitted over a network. A web page 100 is comprised of at least four components: an HTML+text component 102, an Images component 104, a Script component 106, and an Interactive Database Data component 108. Script component 106 and Data component 108 are present when the web page is part of an interactive system where the user can modify, enter, and request information. As is known in the field of internet application programming, HTML component 102 contains HTML code and text. Often this data is not sensitive and does not need to be secured. However, in other cases this may not be the case and such data must be encrypted.

Images component 104 typically contains a high volume of bytes because of the graphics. Normally, when using SSL to send web page 100, every bit in the graphics images must be encrypted. Images component 104 may contain images for advertisements, photographs, logos, backgrounds, or any other type of graphics. Script component 106 contains Java scripts, Visual Basic scripts, applets, Active X controls, or other interactive computer code objects. For web sites and systems that are highly interactive, this data component can be significantly large. This is particularly true for an online application that attempts to operate like a desktop application, that is, attempts to achieve a high degree of interactiveness while keeping the fact that information is being stored and retrieved remotely, transparent to the user. Interactive Database Data component 108 contains information contained in online databases, either as local text files, XML data islands, or as direct access components to the server-side database.

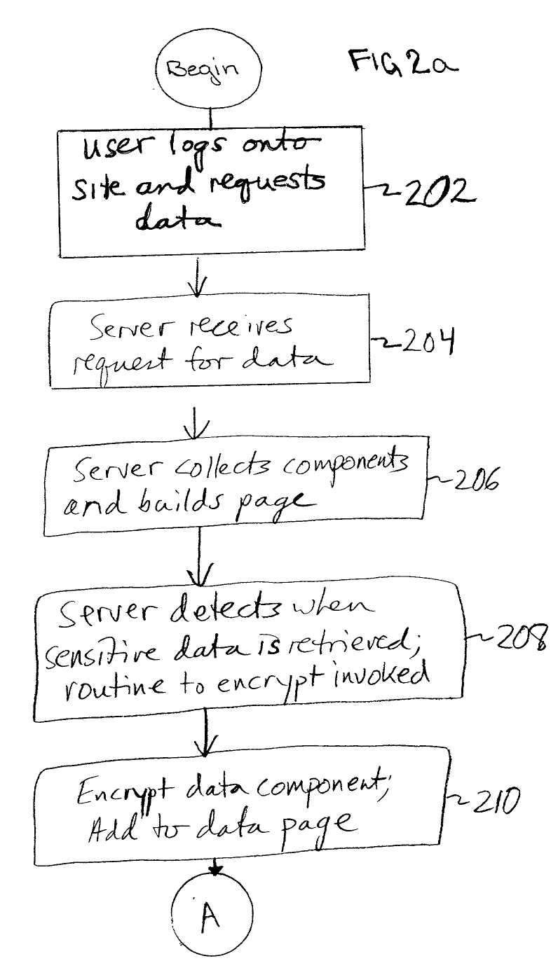

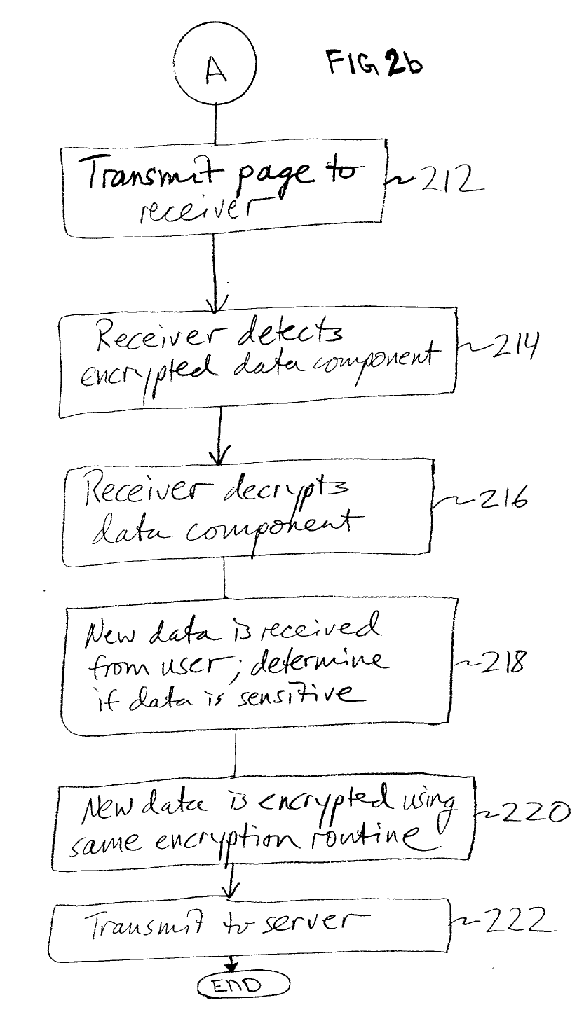

FIGS. 2A and 2B are flow diagrams of a process of securing or encrypting a portion of a web page and transmitting the entire web page over a network in accordance with one embodiment of the present invention. At step 202 the user logs onto a web site and requests her profile or personal information. In the described embodiment, the web site is a health information site that stores health, medical and wellness information for individuals. A consumer creates a profile containing a wide variety of information ranging from prescription drugs to exercise regiments. Naturally, the profile can contain highly personal and sensitive information regarding the individual's health and medical conditions and history. The profile also contains a large volume of public information, such as price, charts for drugs, literature on medical conditions, exercise, diet, and so on, as well as various charts and graphs. Essentially, it is possible that a profile contains a high volume of various types of data. The user logs onto the web site and requests that her health profile be downloaded to her computer.

At step 204 the server supporting the web site receives the request from the user for her health profile. Based on the user's unique login identifier, the server begins building a web page at step 206. This process is generally accomplished using Active Server Pages (ASP) which is a standard programming technique and is known in the computer programming industry In the described embodiment, a web page is similar to the page described in FIG. 1. In other embodiments other types of data components may be present. The server builds a web page by retrieving data components from various sources and databases. This process can be performed in a variety of ways and depends on the type of profile or data set being constructed. In the preferred embodiment, a health profile is constructed of the four data components described above.

At step 208 the ASP code in the server detects when the sensitive data has been requested. In the described embodiment, the sensitive data is the Interactive Database data which may consists of a user's sensitive information. Once the ASP code detects that sensitive data has been requested, a routine to encrypt the data is invoked. The ASP code is able to detect sensitive data based on pre-determined rules and logic in the ASP code as to what is sensitive or non-sensitive data.

At step 210 the sensitive data is encrypted using an encryption routine determined most suitable by the web site operator or service provider. In the described embodiment, the encryption routine is a “plug and play” module. The service provider can decide to use a smaller bit key to secure the data thereby keeping the overhead lower and maintaining a certain level of performance or a larger bit key can be used if the data is highly sensitive. Various factors can be used to determine the most suitable type of encryption routine. The data component is then added to the page as an XML data island together with the other web page components. In this manner, only the sensitive data contained in the web page is encrypted while the other components are left unsecured. Thus, the only overhead resulting from the encryption is limited to the securing of sensitive data only rather than the entire web page. At step 212 the web page containing the user's health profile is transmitted to the client over the internet.

At step 214 the client computer receives the web page and detects the encrypted data component in the page. In the described embodiment, the user downloads an encryption/decryption routine from the service provider's web site. This is typically done when the user signs up initially for the service. Once the client computer detects that there is encrypted data in the web page, the encryption routine is invoked and the sensitive data is decrypted at step 21 6. Once the data is decrypted, it is displayed to the user.

In the described embodiment, there is a high degree of interaction between the user and the profile. Given that the data is health and medical data, the user is constantly updating and modifying information on the profile. The data is formatted in XML using data islands. This format is well known in the field of online application programming. An unencrypted XML Data island has a format such as:

<Data Set>

<SerialNo> 123-98N42 </SerialNo>
<TimeSlot> Nightime </TimeSlot>
<Value>647</Value>

</Data Set>

An encrypted XML data island has a format such as:

<Secure>ffsd87743hdgf85749303vclj,2. . . </Secure>

At step 218 the consumer adds data or modifies data on the web page. At step 220 only the new data is encrypted using the same encryption routine previously downloaded from the server. In the preferred embodiment, only the children nodes of a data island that contain modified data are encrypted. In this manner, only the updated or new data is encrypted and sent back to the server where the user's profile is updated. In the preferred embodiment, the entire profile of the user is not re-encrypted and sent to the server. At step 222 the encryption routine on the server decrypts the data and populates the database. At this stage the process is complete.

Thus, in the present invention portions of a web page are encrypted rather than the entire web page. This is done by taking advantage of the concept or data construct known as XML data islands. A data producer at either the server or the client creates an XML data island containing data, which may already be in XML format, that should be encrypted or, a child of the data island, before being transmitted over a network. Once the sensitive data is wrapped or enclosed in a properly formed XML structure, the data is sent over the network. Any non-sensitive data can be sent unencrypted, thereby significantly reducing the overhead of the data being sent and the transmission time. The non-sensitive data can also be formatted in XML and use XML data islands. Once the receiver gets the encrypted data island or data island child, it can decrypt the data using the same encryption routine used by the sender. The encryption routine can be any routine deemed suitable by the data producer or entity safeguarding the data. Once the data island is decrypted, the data receiver loads the results into the XML document object model (DOM). Once the results are in the DOM, the data elements are extracted from the data island using the appropriate XML document object properties and methods.

In another preferred embodiment, data is transmitted to and received by a device. The device contains firmware that is capable of placing or loading data in XML format and transmitting the XML data. The same technique of using XML data islands to isolate data that needs to be secured before sending it over a network apply to data being sent from the device. By using the standard XML format for sending and receiving data, the device is able to interface with a variety of other devices. By using XML, the interface can extract data using the standard XML DOM. When the device receives data, it translates the unstructured device data into properly formed XML, having XML data islands, allowing the data communications interfaces to be developed using the standard XML DOM. This allows the device to interface across a broad range of devices. Similar to the description above, the XML data islands containing the sensitive data are encrypted and transmitted from the device. In this manner, only the data that needs to be securely transmitted is encrypted before transmission. All the advantages of sending the data from a server or a client in the form of encrypted XML data islands are realized when sending data from an intermediary data device.

What is claimed is:

1. A method of transmitting data over a network, the method comprising:
retrieving a web page, the web page having one or more XML data islands;
selecting which of the one or more XML data islands stores data to be secured before transmitting over the network;
encrypting the one or more selected data islands; and
transmitting the web page with the encrypted data islands and the unencrypted data over the network.

2. A method as recited in claim 1 further comprising receiving a request at a server to retrieve a web page, the web page containing HTML, images, and interactive data.

3. A method as recited in claim 1 wherein selecting which of the one or more XML data islands stores data to be secured before transmitting over the network further comprises determining with data is interactive database data.

4. A method as recited in claim 1 wherein encrypting the one or more data islands further comprises using any suitable encryption routine, wherein the encryption routine is selected based on the level of security desired and a reduction in the amount of overhead.

5. A method as recited in claim 1 wherein the web page is placed in XML format in a device being utilized to receive and transmit between two sources.

6. A method as recited in claim 1 further comprising a computer receiving the web page with the encrypted data and decrypting the data in the XML data islands.

7. A method as recited in claim 1 further comprising adding sensitive data to the web page and wrapping the sensitive data in XML format.

8. A method as recited in claim 7 further comprising encrypting one or more XML data islands of the sensitive data after being placed in XML format.

9. A method of sending secure data over a network, the method comprising:
determining which data needs to be secured before transmitting over a network;
storing the data in an XML data island;
using an encryption routine to encrypt the data stored in the XML data island;
combining the encrypted data with non-encrypted data before transmitting the encrypted data over the network, whereby overhead data as a result of encryption is significantly reduced.
